(19) United States
(12) Patent Application Publication
(10) Pub. No.: US 2015/0170594 A1
(43) Pub. Date: Jun. 18, 2015

(54) DATA DRIVER AND DISPLAY DEVICE USING THE SAME

(71) Applicant: LG Display Co., Ltd., Seoul (KR)

(72) Inventor: Changhun Cho, Gumi-si (KR)

(73) Assignee: LG Display Co., Ltd., Seoul (KR)

(21) Appl. No.: 14/289,506

(22) Filed: May 28, 2014

(30) Foreign Application Priority Data
Dec. 13, 2013 (KR) 10-2013-0155394

(51) Int. Cl. G09G 3/36; G09G 3/32

(52) U.S. Cl. CPC G09G 3/3685; G09G 3/3291; G09G 3/3696; G09G 2330/028; G09G 2300/0828; G09G 2300/0804

(57) ABSTRACT

A data driver of a display panel includes a gamma voltage generating unit generating a gamma grayscale voltage for converting the digital data signal into an analog data signal; and a digital-to-analog conversion unit converting the digital data signal into an analog data signal in response to the gamma grayscale voltage. The gamma voltage generating unit generates the gamma grayscale voltage based on one of an external reference voltage and an internal reference voltage in response to a control signal.

### CROSS-REFERENCE TO RELATED APPLICATION

This application claims the benefit of Korean Patent Application No. 10-2013-0155394 filed on Dec. 13, 2013, which is hereby incorporated by reference.

### BACKGROUND OF THE INVENTION

1. Field of the Invention

The present invention relates to a data driver and a display device using the same.

2. Description of the Related Art

As technology advances, the market for display devices, which present information to users, is expanding. Accordingly, the use of flat panel displays (FPDs) is increasing. Example FPDs include liquid crystal displays (LCDs), organic light emitting diode (OLED) displays, plasma display panels (PDPs), and the like.

An LCD device or an OLED display device includes a display panel including a plurality of subpixels disposed in matrix form and a driver driving the display panel.

The driver includes a gate driver supplying a gate signal (also referred to as a scan signal) to the display panel and a data driver supplying a data signal to the display panel. The data driver converts a digital data signal into an analog data signal in response to a gamma grayscale voltage provided by a gamma voltage generating unit.

In a display device such as an LCD or an OLED display, light is output from selected subpixels to display an image when a scan signal, a data signal, and the like are supplied to the subpixels disposed in a matrix form.

A new data driver is developed when the display device's characteristics such as display panel resolution change. However, components of the data driver excluding a gamma voltage generating unit remain the same. The development of a data driver takes significant time and incurs high costs.

### SUMMARY

In one embodiment, a data driver comprises: a gamma voltage generating unit generating a gamma grayscale voltage for converting the digital data signal into an analog data signal; and a digital-to-analog conversion unit (DA conversion unit) converting the digital data signal into an analog data signal in response to the gamma grayscale voltage. The gamma voltage generating unit generates the gamma grayscale voltage based on one of an external reference voltage and an internal reference voltage in response to a control signal supplied from the outside.

In another aspect, a display device comprises: a display panel; a data driver supplying a data signal to the display panel and having a gamma voltage generating unit; and a reference voltage generating unit supplying an external reference voltage to the gamma voltage generating unit. The data driver generates a gamma grayscale voltage based on one of the external reference voltage and an internal reference voltage in response to the gamma control signal.

### BRIEF DESCRIPTION OF THE DRAWINGS

The accompanying drawings, which are included to provide a further understanding of the invention, are incorporated into and constitute a part of this specification. The drawings illustrate embodiments of the invention and serve to explain the principles of the invention together with the description.

FIG. 1 is a schematic block diagram of an example display device according to an embodiment.

FIG. 2 is a schematic block diagram illustrating a configuration of an example subpixel illustrated in FIG. 1, according to an embodiment.

FIG. 3 is a schematic block diagram conceptually illustrating an example interface between the timing controller and the data driver, according to an embodiment.

FIG. 4 is a schematic block diagram illustrating an example data driver according to an embodiment.

FIG. 5 is a schematic block diagram illustrating an example configuration of a portion of the gamma voltage generating unit illustrated in FIG. 4, according to an embodiment.

FIGS. 6 and 7 illustrate waveform representations of example gamma voltage control signals, according to an embodiment.

### DETAILED DESCRIPTION

Reference will now be made in detail to embodiments of the invention, examples of which are illustrated in the accompanying drawings.

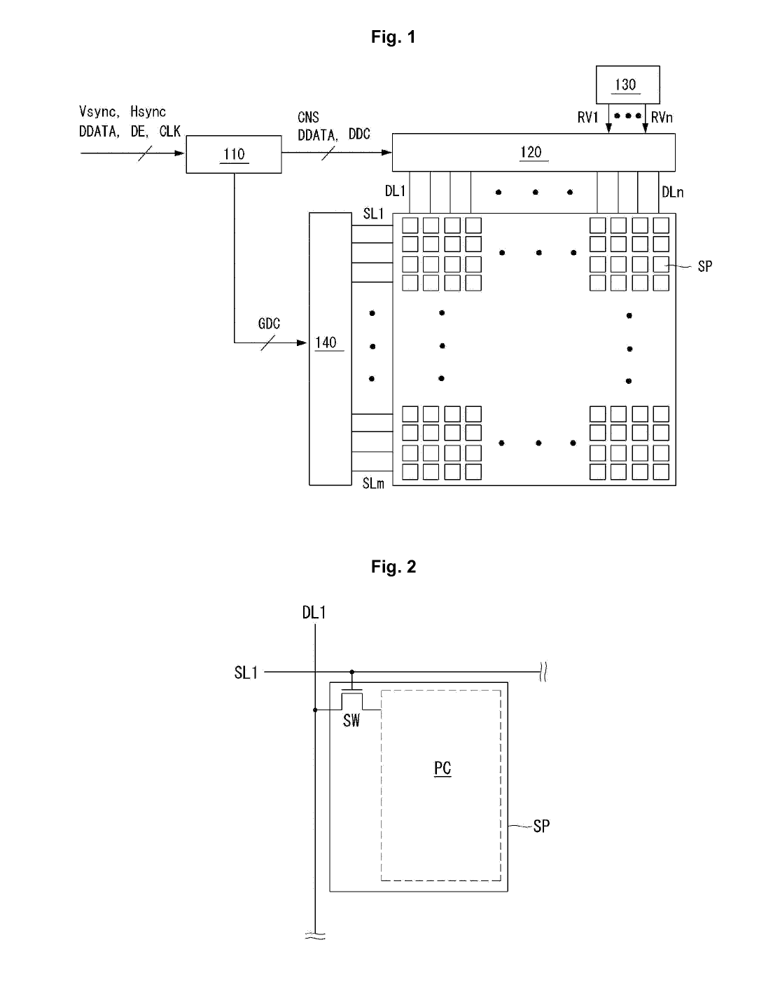

FIG. 1 is a schematic block diagram of a display device according to an exemplary embodiment of the present invention, and FIG. 2 is a view schematically illustrating a configuration of a subpixel illustrated in FIG. 1;

As illustrated in FIG. 1, a display device includes a display panel 150, a timing controller 110, a gate driver 140, a reference voltage generating unit 130, and a data driver 120.

The timing controller 110 receives a vertical synchronizing signal Vsync, a horizontal synchronizing signal Hsync, a data enable signal DE, a clock signal CLK, and a data signal DDATA from the outside. The timing controller 110 controls the operation timing of the data driver 120 and the gate driver 140 by using the timing signals such as the vertical synchronizing signal Vsync, the horizontal synchronizing signal Hsync, the data enable signal DE, and the clock signal CLK.

The timing controller 110 may determine a frame period by counting the data enable signal DE during one horizontal period, so the vertical synchronizing signal Vsync and the horizontal synchronizing signal Hsync may be omitted. Control signals generated by the timing controller 110 include a gate timing control signal GDC for controlling the operation timing of the gate driver 140 and a data timing control signal DDC for controlling the operation timing of the data driver 120. The control signals generated by the timing controller 110 include a gamma control signal CNS for controlling a gamma voltage generating unit included in the data driver 120. The timing controller 110 is mounted in the form of an integrated circuit (IC) on an external board.

The display panel 150 displays an image in response to the gate line outputs from the gate driver 140 on the gate lines SL1 to SLm and the data line outputs from the data driver 120 on the data lines DL1 to DLn. The display panel 150 includes subpixels SP positioned between a lower substrate and an upper substrate. The subpixels SP operate in response to the gate line outputs and the data line outputs, which reflect the digital data signal DDATA.

FIG. 2 is a schematic block diagram illustrating a configuration of an example subpixel SP illustrated in FIG. 1, according to an embodiment. A subpixel includes a switching transistor SW connected to a gate line SL1 and a data line DL1. The subpixel also includes a pixel circuit PC operating in response to the data signal DDATA supplied through the switching transistor SW. The configuration of the pixel circuit PC depends on whether the subpixels SP are liquid crystal elements (as part of an LCD panel) or organic light emitting elements (as part of an OLED display panel).

If the display panel 150 is an LCD panel, the subpixel SP includes a switching thin film transistor (TFT) SW, a storage capacitor, a pixel electrode, a common electrode, a liquid crystal layer, a color filter, a black matrix, and the like, for example. Continuing the example, when a gate signal and a data signal are supplied from the gate driver 140 and the data driver 120, respectively, a data voltage is stored in the storage capacitor to drive the switching TFTs SW in the subpixels SP. Thereafter, a data voltage is supplied to the pixel electrode, a common voltage is supplied to the common electrode, and the liquid crystal layer tilts under the influence of an electric field formed between the pixel electrode and the common electrode. Through this process, the liquid crystal layer controls transmittance of light from a backlight unit, and the liquid crystal panel displays an image. If the display panel 150 is configured as an LCD panel, then it may implemented using twisted nematic (TN) mode, vertical alignment (VA) mode, in-plane switching (IPS) mode, fringe-field switching (FFS) mode, or electrically controlled birefringence (ECB) mode, for example.

If the display panel 150 is an OLED display panel, the subpixel SP includes a switching TFT (SW), a driving TFT, a capacitor, an organic light emitting diode (OLED), and the like, for example. In this example, when a gate signal and a data signal are supplied from the gate driver 140 and the data driver 120, respectively, a data voltage is stored in the capacitor to drive the switching TFT (SW) in the subpixel SP. As the driving TFT is driven by the data voltage, a driving current flows to an anode electrode and a cathode electrode of the OLED. Through this process, the OLED emits a quantity of light controlled by the driving current flowing through the OLED, and the OLED display panel displays an image. If the display panel 150 is configured as an OLED display panel, then it may be implemented as a top-emission type panel, a bottom-emission type panel, or a dual-emission type panel, for example.

In response to the data timing control signal DDC supplied from the timing controller 110, the data driver 120 samples the digital data signal DDATA supplied from the timing controller 110 and latches the sampled DDATA. In response to a gamma grayscale voltage (also referred to as a gamma gray voltage or a gamma gradation voltage) output from the gamma voltage generating unit, the data driver 120 converts the digital data signal DDATA into an analog data signal ADATA. The data driver 120 supplies the converted analog data signal ADATA to the subpixels SP included in the display panel 150 through data lines DL1 to DLn. The data driver 120 is mounted as an integrated circuit (IC) on an external board or mounted in a non-display region of the display panel 150.

The reference voltage generating unit 130 outputs first to nth reference voltages RV1 to RVn based on a voltage supplied from the outside of the data driver 120. The first to nth reference voltages RV1 to RVn output by the reference voltage generating unit 130 are supplied to the gamma voltage generating unit included in the data driver 120. The reference voltage generating unit 130 is formed as an IC on an external board or formed on the same board as the data driver 120. Since the reference voltage generating unit 130 is separately formed outside of the data driver 120, the first to nth reference voltages RV1 to RVn may be referred to as external reference voltages.

In response to the gate timing control signal GDC supplied from the timing controller 110, the gate driver 140 sequentially generates a gate signal (e.g., gate high voltage) to sequentially operate the subpixels SP of the display panel 150 by switching on the corresponding transistors. The gate driver 140 supplies the generated gate signal to the subpixels SP included in the display panel 150 through gate lines SL1 to SLm. The gate driver 140 may be formed as an IC on an external board or may be formed in a gate-in-panel configuration in a non-display region of the display panel 150.

The data driver 120 used in a display device such as an LCD or an OLED display as described above is designed for characteristics of the display panel, such as its resolution, even though many of the components of the data driver 120 remain the same, with the exception of the gamma voltage generating unit. Designing and developing the data driver 120 takes substantial time and incurs large costs; however, these costs may be mitigated as follows.

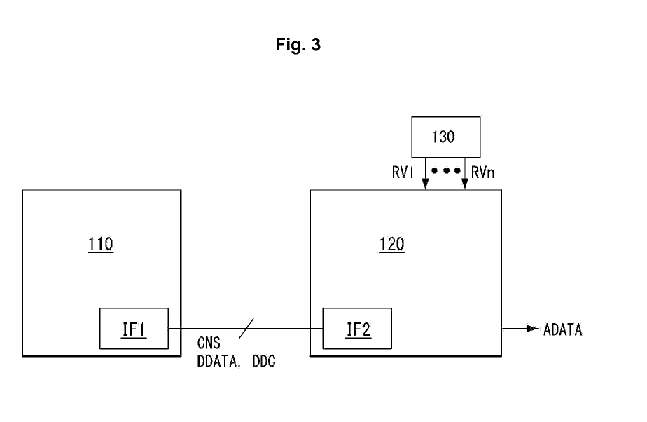

FIG. 3 is a schematic block diagram conceptually illustrating an example interface between the timing controller 110 and the data driver 120, according to an embodiment. The timing controller 110 and the data driver 120 are electrically connected by interfaces IF1 and IF2 capable of transmitting and receiving data between each other. For example, the interfaces IF1 and IF2 of the timing controller 110 and the data driver 120 are connected in a serial communication manner.

The timing controller 110 supplies data packets to the data driver 120. These data packets include the data signal DDATA, the data timing control signal DDC, the gamma control signal CNS, and the like. The gamma control signal CNS includes signals for controlling a decoder unit and a multiplexing unit included in the gamma voltage generating unit of the data driver 120.

In response to the data timing control signal DDC, the data driver 120 converts the digital data signal DDATA into analog data signal ADATA and outputs the same. When the data driver 120 converts the digital data signal DDATA into the analog data signal ADATA, the data driver 120 refers to the first to nth reference voltages RV1 to RVn supplied from the reference voltage generating unit 130 or refers to the gamma control signal CNS supplied from the timing controller 110. In other words, the data driver 120 converts the data signal in response to the reference voltage supplied from the reference voltage generating unit 130 or converts the data signal in response to the gamma control signal CNS from the timing controller 110.

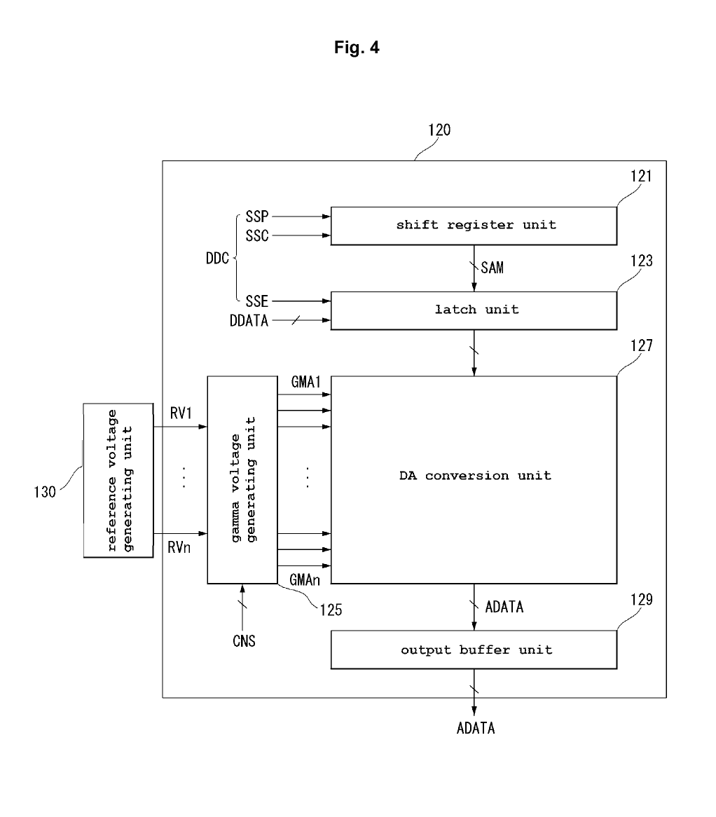

FIG. 4 is a schematic block diagram illustrating an example data driver 120 according to an embodiment. The data driver 120 includes a shift register unit 121, a latch unit 123, a gamma voltage generating unit 125, a DA conversion unit 127, and an output buffer unit 129.

The data timing control signal DDC output by the timing controller 110 includes a source start pulse (SSP), a source sampling clock (SSC), a source output enable (SSE) signal, and the like. The SSP controls a data sampling start point of the data driver 120. The SSC is a clock signal for controlling frequency of data sampling in the data driver 120 based on a rising edge or a falling edge of the clock signal. The SSE controls an output of the data driver 120.

The shift register unit 121 outputs a sampling signal SAM in response to the SSP and the SSC output by the timing controller 110.

The latch unit 123 sequentially samples the digital data signal DDATA in response to the sampling signal SAM output from the shift register unit 121, and simultaneously outputs the sample data signal DDATA of one line portion in response to the SSE. Although a single latch unit 123 is illustrated and described, the latch unit 123 may also be configured as multiple latch units.

The DA conversion unit 127 converts the data signal DDATA of one line portion into an analog data signal ADATA in response to the first to nth gamma grayscale voltages GMA1 to GMAn output by the gamma voltage generating unit 125. The DA conversion unit 127 converts the gamma grayscale voltages into positive polarity and negative polarity data signals ADATA in response to a polarity control signal supplied from the timing controller 110. The polarity control signal may be inverted from one horizontal line of pixels to the next horizontal line of pixels.

The output buffer unit 129 amplifies (or amplifies and compensates for) the data signal ADATA output from the DA conversion unit 127 and outputs the modified ADATA signal to the data lines DL1 to DLn.

The gamma voltage generating unit 125 generates the first to nth gamma grayscale voltages GMA1 to GMAn. The first to nth gamma grayscale voltages GMA1 to GMAn include a positive polarity gamma grayscale voltage and a negative polarity gamma grayscale voltage. In other words, the gamma voltage generating unit 125 includes a positive polarity gamma voltage generating unit that generates a positive polarity gamma grayscale voltage and a negative polarity gamma voltage generating unit that generates a negative polarity gamma grayscale voltage.

The gamma voltage generating unit 125 generates the first to nth gamma grayscale voltages GMA1 to GMAn based on external reference voltages RV1 to RVn from the reference voltage generating unit 130 provided outside of the data driver 120, or based on internal reference voltages generated based on the gamma control signal CNS supplied from the timing controller 120. The gamma control signal CNS includes both a selection signal and a decoder control signal. The selection signal determines whether the gamma voltage generating unit 125 generates the gamma grayscale voltages GMA1 to GMAn based on the external reference voltages from the reference voltage generating unit 130 or based on the decoder control signal of the gamma control signal CNS. Hence, the gamma control signal CNS selects whether the gamma gray voltages GMA1 to GMAn are based on internal reference voltages or based on external reference voltages.

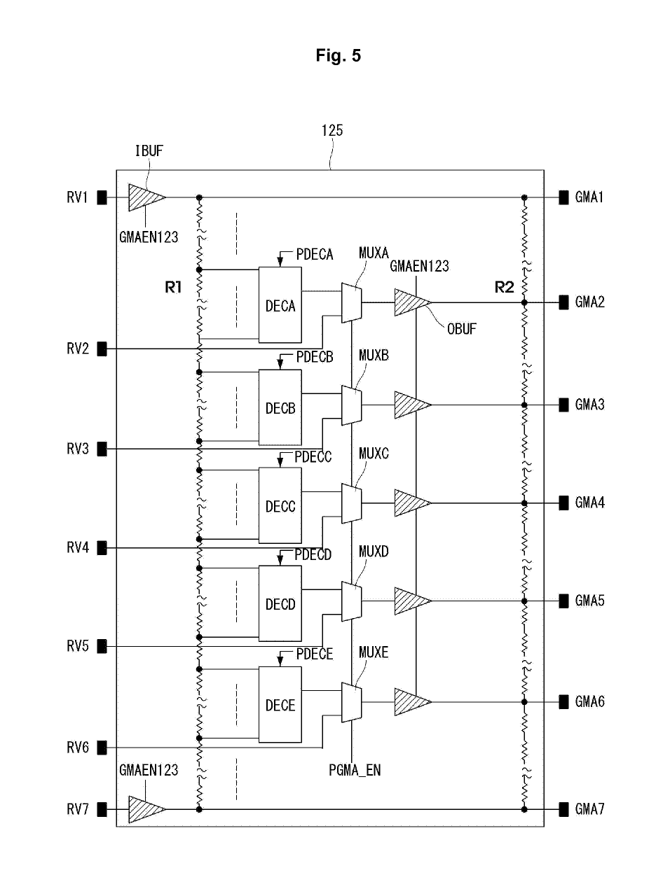

FIG. 5 is a schematic block diagram illustrating an example configuration of a portion of the gamma voltage generating unit 125 illustrated in FIG. 4, according to an embodiment. The gamma voltage generating unit 125 includes input buffer units IBUF, a first resistor string R1, decoder units DECA to DECE, multiplexing units MUXA to MUXE, output buffer units OBUF, and a second resistor string R2. The illustrated gamma voltage generating unit 125 represents a positive gamma voltage generating unit that generates first to seventh gamma grayscale voltages GMA1 to GMA7 in response to a voltage or a signal supplied from the outside. The configuration of a negative polarity gamma voltage generating unit that generates a negative polarity gamma grayscale voltage may be inferred from the illustrated positive gamma voltage generating unit.

The illustrated gamma voltage generating unit 125 corresponds to a case where n is seven, so there are seven gamma grayscale voltages GMA1 to GMA7 and seven reference voltages RV1 to RV7. However, various embodiments may have different values of n. These embodiments may include fewer or additional decoder units (such as DECA to DECE), multiplexing units (such as MUXA to MUXE), output buffer units OBUF, and decoder control signals PDECA to PDECE corresponding to the value of n.

The input terminals of the first and second input buffer units IBUF are connected to the first and nth input terminals to which reference voltages RV1 and RVn are supplied, respectively. An output terminal of the first and second input buffer units IBUF are connected to first and nth output terminals to which the first to nth gamma grayscale voltages GMA1 to GMAn are output.

The first input terminal to which the first reference voltage RV1 is supplied and nth input terminal to which the nth reference voltage RVn is supplied correspond to a black grayscale (a low grayscale value) and a white grayscale (a high grayscale value), respectively. Alternatively, the first input terminal and the nth input terminal may correspond to a white grayscale and a black grayscale according to characteristics of a display panel, respectively. The input buffer units IBUF serve to adjust a gamma tap voltage of the black grayscale and the white grayscale in response to a gamma activation signal GMAEN123.

The first resistor string R1 includes a plurality of resistors connected in series between the first input terminal to which the first reference voltage RV1 is supplied and the nth input terminal to which the nth reference voltage RVn is supplied. The first resistor string R1 has nodes dividing the resistor string R1 into predetermined sections. Each decoder unit DECA to DECE is connected to N nodes of the resistor string R1, where N is an integer greater than or equal to 2.

The first resistor string R1 divides the reference voltages RV1 and RVn into intermediate voltages between RV1 and RVn. In general, the resistors of the first resistor string R1 are designed to have different resistance values in different predetermined sections. Thus, the decoder units DECA to DECE receive different voltages from the predetermined sections of the first resistor string R1.

The decoder units DECA to DECE output second to sixth internal reference voltages having intermediate grayscale values supplied to the multiplexer units MUXA to MUXE. The first and nth input terminals supplying reference voltages RV1 and RVn (RV7 in the example of FIG. 5) are not connected to the decoder units DECA to DECE. More generally, n−2 decoder units supply n−2 internal reference voltages. The outputs of the decoder units DECA to DECE may be referred to as internal reference voltages.

The decoder units DECA to DECE are connected to the nodes of the first resistor string R1, respectively. The decoder units DECA to DECE receive different voltages from the first resistor string R1 and each decodes these received voltages to output a single reference voltage.

In response to decoder control signals PDECA to PDECE, which are included in the gamma control signals CNS supplied from the timing controller 110, the decoder units DECA to DECE modify how they decode voltages in response to the received voltages from the resistor string R1. The decoder control signals PDECA to PDECE may be received in the data packets containing the gamma control signals CNS, so the decoder units DECA to DECE output second to sixth reference voltages in response to logical bit values of the decoder control signals PDECA to PDECE in the form of data packets. Hence, the decoder units DECA to DECE output internal reference voltages and are programmable according to the logical bit values of the decoder control signals PDECA to PDECE, respectively.

In response to a multiplexing control signal PGMA_EN, which is included in the gamma control signals CNS supplied from the timing controller 110, the multiplexing units MUXA to MUXE selectively output either the second to sixth reference voltages RV2 to RV6 from the reference voltage generating unit 130 or the second to sixth reference voltages output from the decoder units DECA to DECE.

The first input terminals of the multiplexing units MUXA to MUXE are connected to the output terminals of the decoder units DECA to DECE; the second input terminals thereof are connected to second to sixth input terminals corresponding to terminals of intermediate grayscales; and the output terminals thereof are connected to the input terminals of the output buffer units OBUF, respectively. In response to the multiplexing control signal PGMA_EN, the multiplexing units MUXA to MUXE output second to sixth reference voltages input through the first input terminals or output second to sixth reference voltages input through the second input terminals.

The input terminals of the output buffer units OBUF are connected to the output terminals of the multiplexing units MUXA to MUXE, respectively, and the output terminals thereof are connected to the second to sixth output terminals from which the second to sixth gamma grayscale voltages GMA2 to GMA6 are output. The output buffer units OBUF serve to adjust a gamma tap voltage of an intermediate grayscale in response to a gamma activation signal GMAEN123.

The second resistor string R2 includes a plurality of resistors connected in series between a first output terminal from which the first gamma grayscale voltage GMA1 is output and an nth output terminal from which the nth gamma grayscale voltage GMAn is output. The second resistor string R2 has nodes dividing the resistor string R2 into predetermined sections. The output terminals of the output buffer units OBUF are each connected to a node of the resistor string R2.

The second resistor string R2 partitions the first and nth gamma grayscale voltages GMA1 and GMAn into intermediate voltages to form gamma grayscale voltages GMA1 to GMAn output from the first to nth output terminals as particular voltages. In general, the resistors of the second resistor string R2 have different resistance values in each of the predetermined sections. Thus, the gamma voltage generating unit 125 outputs different first to nth gamma grayscale voltages GMA1 to GMAn for each output terminal.

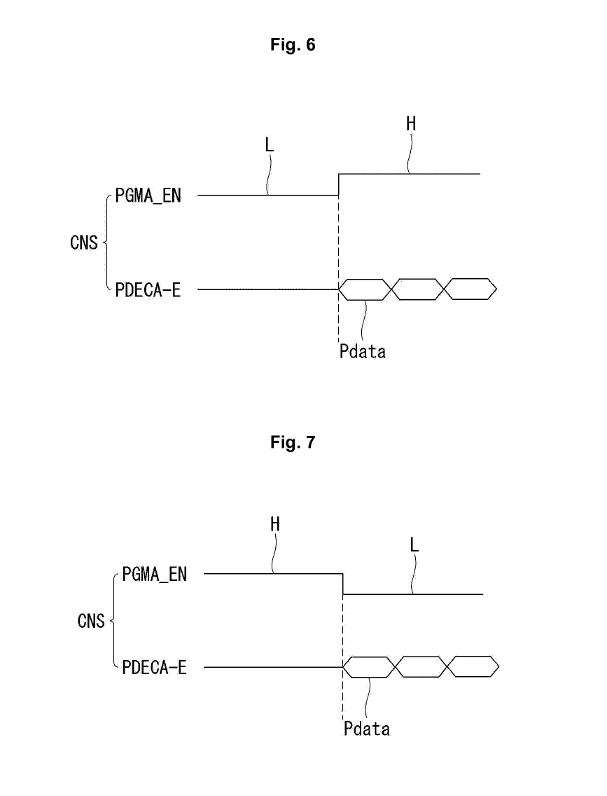

FIGS. 4 through 6 illustrate a configuration in which the multiplexing units MUXA to MUXE are deactivated when the multiplexing control signal PGMA_EN is logically low (L). In this case, the decoder control signals PDECA to PDECE may not be supplied in received data packets of the gamma control signal CNS.

If the multiplexing control signal PGMA_EN is logically low (L), the gamma voltage generating unit 125 outputs the gamma grayscale voltages GMA1 to GMAn with reference to the reference voltages RV1 to RVn supplied from the reference voltage generating unit 130.

If the multiplexing control signal PGMA_EN is logically high (H), the multiplexing units MUXA to MUXE are activated. In this case, the decoder control signals PDECA to PDECE are supplied as data packets. The data packets Pdata of the decoder control signals PDECA to PDECE may have M bits, where M is greater than or equal to 2.

If the multiplexing control signal PGMA_EN is logically high (H) and the decoder control signals PDECA to PDECE have data packets, the gamma voltage generating unit 125 outputs gamma grayscale voltages GMA2 to GMAn−1 of an intermediate grayscale based on the second to sixth reference voltages output from the decoder units DECA to DECE. The gamma voltage generating unit 125 outputs the gamma grayscale voltages GMA1 and GMAn (of high and low grayscale) with reference to the reference voltages RV1 and RVn.

FIGS. 4, 5, and 7 illustrate a configuration in which the multiplexing units MUXA to MUXE are deactivated when the multiplexing control signal PGMA_EN is logically high (H). In this case, the decoder control signals PDECA to PDECE may not be supplied in received data packets of the gamma control signal CNS.

If the multiplexing control signal PGMA_EN is logically high (H), the gamma voltage generating unit 125 outputs the gamma grayscale voltages GMA1 to GMAn with reference to the reference voltages RV1 to RVn supplied from the reference voltage generating unit 130.

If the multiplexing control signal PGMA_EN is logically low (L), the multiplexing units MUXA to MUXE are activated. In this case, the decoder control signals PDECA to PDECE are supplied with data packets Pdata. The data packets Pdata of the decoder control signals PDECA to PDECE may have M bits, where M is greater than or equal to 2.

If the multiplexing control signal PGMA_EN is logically low (L) and the decoder control signals PDECA to PDECE have data packets, the gamma voltage generating unit 125 outputs gamma grayscale voltages GMA2 to GMAn−1 of an intermediate grayscale with reference to the second to sixth reference voltages output from the decoder units DECA to DECE. The gamma voltage generating unit 125 outputs the gamma grayscale voltages GMA1 and GMAn (of high and low grayscale) with reference to the reference voltages RV1 and RVn.

As can be seen from the above description, when the multiplexing units MUXA to MUXE are activated by the gamma control signal CNS supplied from the timing controller 110, the data driver 120 may generate the gamma tap voltage of intermediate grayscale values, excluding a low grayscale and a high grayscale, based on the data packets. Also, when the multiplexing units MUXA to MUXE are deactivated by the gamma control signal CNS supplied from the timing controller, the data driver 120 may generate the gamma tap voltage of grayscale values based on a reference voltage supplied by the reference voltage generating unit 130.

Since the data driver 120 may change the gamma grayscale voltage output from the gamma voltage generating unit 125 in response to the gamma control signal CNS supplied from the timing controller 110, the data driver 120 may be commonly used across a wide variety of device characteristics such as display resolution. Thus, since the data driver 120 that may be commonly used across a wide variety of display device designs, the data driver 120 reduces development costs of devices with different device characteristics such as display resolution.

What is claimed is:

1. A data driver comprising:
a gamma voltage generating unit generating a gamma grayscale voltage for converting the digital data signal into an analog data signal, the gamma grayscale voltage generated based on one of an external reference voltage and an internal reference voltage in response to a control signal; and
a digital-to-analog conversion unit converting a digital data signal into an analog data signal in response to the gamma grayscale voltage.

2. The data driver of claim 1, wherein the gamma voltage generating unit comprises:
a decoder unit generating an internal reference voltage corresponding to an intermediate grayscale between a low grayscale and a high grayscale in response to the control signal; and
a multiplexing unit outputting one of the external reference voltage and the internal reference voltage in response to the control signal.

3. The data driver of claim 2, wherein the gamma voltage generating unit generates the gamma grayscale voltage based on the internal reference voltage in response to activation of the multiplexing unit, and the gamma voltage generating unit generates the gamma grayscale voltage based on the external reference voltage in response to deactivation of the multiplexing unit.

4. The data driver of claim 2, wherein the gamma voltage generating unit generates the gamma grayscale voltage based on the internal reference voltage in response to deactivation of the multiplexing unit, and the gamma voltage generating unit generates the gamma grayscale voltage based on the external reference voltage in response to activation of the multiplexing unit.

5. The data driver of claim 1, wherein the gamma grayscale voltage comprises a plurality of gamma grayscale voltages and the external reference voltage comprises a plurality of external reference voltages, and wherein the gamma voltage generating unit further comprises:
a first input buffer outputting a first gamma grayscale voltage corresponding to a low grayscale;
a second input buffer outputting a second gamma grayscale voltage corresponding to a high grayscale;
a plurality of decoder units generating a plurality of internal reference voltages corresponding to a plurality of intermediate grayscales between the low grayscale and the high grayscale in response to the control signal; and
a plurality of multiplexing units each selectively outputting either one of the external reference voltages or one of the internal reference voltages in response to the control signal.

6. The data driver of claim 5, wherein the gamma voltage generating unit further comprises:
a resistor string connecting the first gamma grayscale voltage and the second gamma grayscale voltage, the resistor string having a plurality of nodes, each of the plurality of decoder units connected to the resistor string at two or more nodes and generating an internal reference voltage in response to voltages at the two or more nodes.

7. A display device comprising:
a display panel;
a data driver supplying a data signal to the display panel and having a gamma voltage generating unit generating a gamma grayscale voltage based on one of an external reference voltage and an internal reference voltage; and
a reference voltage generating unit supplying the external reference voltage to the gamma voltage generating unit.

8. The display device of claim 7, further comprising:
a timing controller supplying a gamma control signal to the data driver, the gamma voltage generating unit selecting between the external reference voltage and the internal reference voltage in response to the gamma control signal.

9. The display device of claim 8, wherein the gamma voltage generating unit comprises:
a decoder unit generating an internal reference voltage corresponding to an intermediate grayscale between a low grayscale and a high grayscale in response to the gamma control signal; and
a multiplexing unit outputting one of the external reference voltage and the internal reference voltage in response to the gamma control signal.

10. The display device of claim 9, wherein, the gamma voltage generating unit generates the gamma grayscale voltage based on the internal reference voltage in response to activation of the multiplexing unit, and the gamma voltage generating unit generates the gamma grayscale voltage based on the external reference voltage in response to deactivation of the multiplexing unit.

11. The display device of claim 9, wherein, the gamma voltage generating unit generates the gamma grayscale voltage based on the internal reference voltage in response to deactivation of the multiplexing unit, and the gamma voltage generating unit generates the gamma grayscale voltage based on the external reference voltage in response to activation of the multiplexing unit.

12. The display device of claim 8, wherein the timing controller and the data driver are connected via a serial communication to transfer data packets.

13. The display device of claim 8, wherein the gamma grayscale voltage comprises a plurality of gamma grayscale voltages and the external reference voltage comprises a plurality of external reference voltages, and wherein the gamma voltage generating unit further comprises:
a first input buffer outputting a first gamma grayscale voltage corresponding to a low grayscale;
a second input buffer outputting a second gamma grayscale voltage corresponding to a high grayscale;
a plurality of decoder units generating a plurality of internal reference voltages corresponding to a plurality of intermediate grayscales between the low grayscale and the high grayscale in response to the control signal; and
a plurality of multiplexing units each selectively outputting either one of the external reference voltages or one of the internal reference voltages in response to the control signal.

14. The display device of claim 13, wherein the gamma voltage generating unit further comprises:
a resistor string connecting the first gamma grayscale voltage and the second gamma grayscale voltage, the resistor string having a plurality of nodes, each of the plurality of decoder units connected to the resistor string at two or more nodes and generating an internal reference voltage in response to voltages at the two or more nodes.
